(19) United States
(12) Patent Application Publication
(10) Pub. No.: US 2002/0119700 A1
(43) Pub. Date: Aug. 29, 2002

(54) Connector

(75) Inventor: Takao Murakami, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/077,929

(22) Filed: Feb. 20, 2002

(30) Foreign Application Priority Data
Feb. 26, 2001 (JP) P 2001-050371

(51) Int. Cl. H01R 13/58

(52) U.S. Cl. 439/606

(57) ABSTRACT

A connector is provided with a covered electric wire in which a front end of a core is exposed by peeling off a coating, a terminal provided with a caulking portion having one or more openings, and a resin housing in which an outer periphery of the terminal and a part of the insulator are inserted therein. The caulking portion clamps the core with exposing a part of the core from the openings. The resin is impregnated to the core not only from both ends of the caulking portion but also from the openings.

### BACKGROUND OF THE INVENTION

1. Field of the Invention

The present invention relates to a connector in which a terminal connected to a terminal end of a covered electric wire is covered by housing made of a resin.

2. Description of the Related Art

A conventional connector is provided with a connecting means provided in a terminal end of a covered electric wire covered by a coating made of a resin around an outer periphery of a core constituted by a plurality of electric conductors, that is, a terminal connected to a terminal end of the covered electric wire, and a housing covering the terminal and the terminal end of the covered electric wire.

The terminal is manufactured by punching a metal or the like having a conductivity. One side thereof is bent in a tubular shape so as to form a contact portion being in contact with an opposing terminal, and another side thereof forms an insulator caulking portion caulked to the coating of the terminal end of the covered electric wire and a core caulking portion caulked to a core exposed by peeling off the coating at the terminal end of the covered electric wire.

The housing is made of a resin, covers an outer periphery from the contact portion of the terminal to the coating at the terminal end of the covered electric wire, and has the terminal end of the covered electric wire inserted into an inner portion thereof. Further, the housing is provided with an insertion opening to which the opposing terminal is inserted so as to make it possible to connect the contact portion of the terminal to the opposing terminal.

At a time of assembling the connector mentioned above, at first, the core is previously exposed by peeling off the coating at the terminal end of the covered electric wire, and the core caulking portion and the coating caulking portion are respectively caulked to the core and the coating. Next, the housing is molded on the terminal end of the covered electric wire and the outer periphery of the terminal.

Since the terminal end of the covered electric wire and the outer periphery of the terminal are inserted and covered by the housing, the terminal end of the covered electric wire is impregnated with the resin between a plurality of conductors within the core, it is possible to prevent a water content from enter between the conductors.

### SUMMARY OF THE INVENTION

In the conventional connector mentioned above, since the core is molded in a state of being caulked in the core caulking portion, an interval between the conductors is small, and an efficiency at which the resin is impregnated is not good.

As a result, since the resin is hardened before the resin securely enters between a plurality of conductors within the core, a waterproof of the core is not sufficient, and there is a case that the conductors are oxidized. In this case, a durability of the covered electric wire is reduced, and there is a risk that an electric resistance of the covered electric wire is significantly increased.

An object of the present invention is to provide a connector, which can improve a waterproof performance within a core.

A connector according to a first aspect of the present invention is provided with an electric wire covered with an insulator in which a front end of a core is exposed by peeling off a coating, a terminal provided with a plurality of pairs of crimp arms arranged in a longitudinal direction, and a resin housing in which an outer periphery of the terminal and a part of the insulator are molded therein. The crimp arms respectively clamp the core with leaving an interval between each other, and the core are exposed from the interval. The resin is impregnated to the core not only from both ends of the crimp arms but also from the interval.

A connector according to a second aspect of the present invention is provided with a covered electric wire in which a front end of a core is exposed by peeling off a coating, a terminal provided with a caulking portion having one or more openings, and a resin housing in which an outer periphery of the terminal and a part of the insulator are inserted therein. The caulking portion clamps the core with exposing a part of the core from the openings. The resin is impregnated to the core not only from both ends of the caulking portion but also from the openings.

In the case of either structure, the core from which the coating at the terminal end of the covered electric wire is peeled off is clamped to the caulking portion so as to be connected to the terminal. The core at the terminal end of the covered electric wire is exposed not only from both ends of the caulking portion but also from the interval or the opening. Since the core is molded with the resin in this state, the resin is impregnated to the core not only from both ends of the caulking portion but also from the opening. In comparison with the case of the prior art, since the resin is more efficiently impregnated, the resin securely enters between a plurality of conductors within the core, so that it is possible to sufficiently waterproof the core.

### BRIEF DESCRIPTION OF THE DRAWINGS

FIG. 1 is a cross sectional view of a connector according to a first embodiment of the present invention;

FIG. 2 is a plan view in a developing state of a terminal according to the first embodiment of the present invention; and

FIG. 3 is a plan view in a developing state of a terminal according to a second embodiment of the present invention.

### DETAILED DESCRIPTION OF THE PREFERRED EMBODIMENT

A description will be given below of embodiments of a connector according to the present invention.

<First Embodiment>

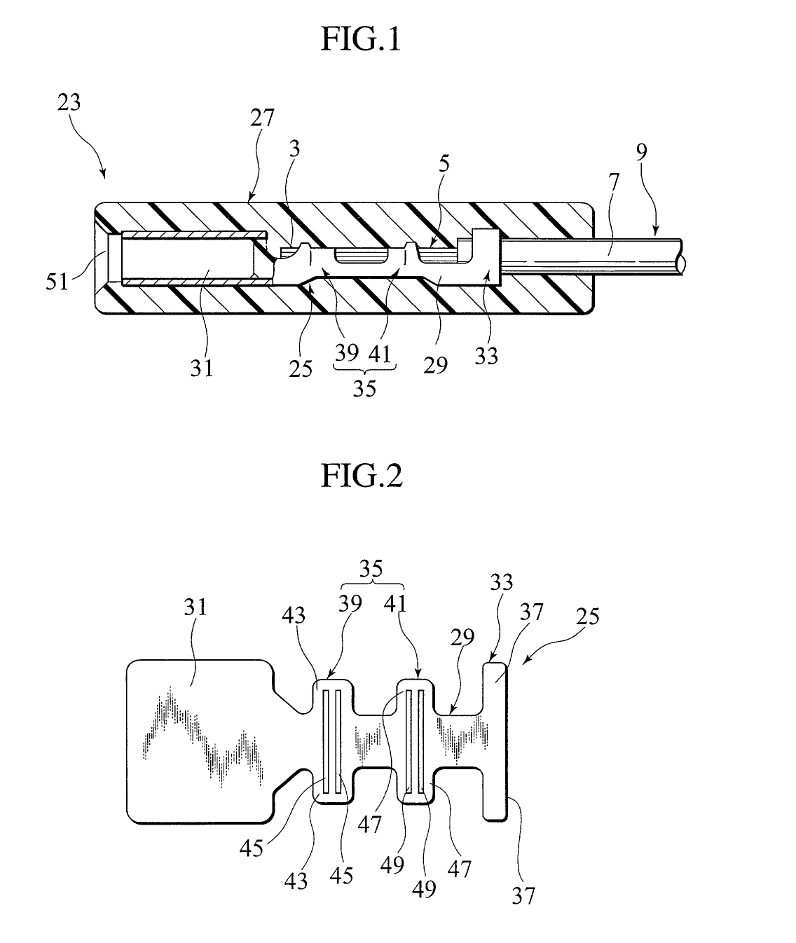

A connector 23 is connected to a terminal end of a covered electric wire 9 in which a core 5 comprising a plurality of conductors 3 having an insulator 7 peeled off is exposed at a predetermined length, as shown in FIG. 1, and is constituted by a terminal 25 connected to the terminal end of the covered electric wire 9 and a housing covering an outer periphery of the terminal 25 and in which the terminal end of the covered electric wire 9 is inserted in an inner portion.

The terminal 25 in a developed state is formed by punching a metal plate or the like having a conductivity, as shown in FIGS. 1 and 2. It is constituted by a rectangular plate-like terminal main body 29, a contact portion 31 provided in one side in a longitudinal direction of the terminal main body 29 and bent in a tubular shape, an insulator caulking portion 33 provided in another side of the terminal main body 29 and caulked to the insulator 7 at the terminal end of the covered electric wire 9, and a core caulking portion 35 provided between the contact portion of the terminal main body 29 and the insulator caulking portion 33 and caulked to the core 5 at the terminal end of the covered electric wire 9.

The contact portion 31 is formed in a substantially quadrate flat plate shape in a developed state, and is extended in a longitudinal direction from one side of the terminal main body 29. Further, the contact portion 31 is structured such that both sides in a width direction protrude outward with respect to both sides in a width direction of the terminal main body 29. The contact portion 31 is formed in a longitudinal hollow tubular shape by bending both sides in the width direction, as shown in FIG. 1, and an opposing terminal is inserted to an inner portion thereof so as to be in contact with the contact portion 31. Further, the insulator caulking portion 33 is provided in another side of the terminal main body 29 in which the contact portion 31 is provided in one side in the longitudinal direction.

A pair of rectangular plate-like supporting arms 37, as shown in FIG. 2 forms the insulator caulking portion 33. The supporting arms 37 are extended in a width direction from both sides in the width direction of another side of the terminal main body 29. Further, the supporting arms 37 are formed so as to have a slightly smaller size than a size in a peripheral direction of an outer peripheral surface of the insulator 7 between front ends thereof.

Further, the supporting arms 37 are respectively pressure attached to the insulator 7 in a caulking state of the insulator 7 at the terminal end of the covered electric wire 9 executed by the insulator caulking portion 33 so as to support the covered electric wire 9. In this case, the insulator caulking portion 33 may be properly omitted according to a use aspect of the terminal 25 or the like.

The core caulking portion 35 provided between the insulator caulking portion 33 and the contact portion 31 as mentioned above is constituted by a first caulking portion 39 provided in one side of the terminal main body 29 and a second caulking portion 41 provided in another side of the terminal main body 29 with respect to the first caulking portion 39. The first caulking portion 39 is constituted by a pair of rectangular plate-like first crimp arms 43, and these are respectively extended in a width direction from both sides in the width direction of the terminal main body 29. These first crimp arms 43 are formed so as to have a slightly smaller size than a size in the peripheral direction of the outer peripheral surface of the core 5 between front ends. Further, the first crimp arms 43 are respectively pressure attached to the core 5 in a caulking state of the core 5 at the terminal end of the covered electric wire 9 executed by the core caulking portion 35. Further, a pair of protrusions 45 engaging with the core 5 in the caulking state of the core 5 executed by the core caulking portion 35 are provided between the front ends of the first crimp arms 43.

The second caulking portion 41 is constituted by a pair of rectangular plate-like second crimp arms 47 which are formed substantially the same shape as in the case of the first caulking portion 39, and these are respectively extended in a width direction from both sides in the width direction of the terminal main body 29. These second crimp arms 47 are formed so as to have a slightly smaller size than a size in the peripheral direction of the outer peripheral surface of the core 5 between front ends. Further, the second crimp arms 47 are respectively pressure attached to the core 5 in a caulking state of the core 5 at the terminal end of the covered electric wire 9 executed by the core caulking portion 35. Further, a pair of protrusions 49 engaging with the core 5 in the caulking state of the core 5 executed by the core caulking portion 35 are provided between the front ends of the second crimp arms 47.

The second caulking portion is arranged in a substantially middle portion between the first caulking portion 39 and the insulator caulking portion 33, and has a predetermined pitch in a longitudinal direction of the terminal main body 29 between the first caulking portion 39 and the insulator caulking portion 33. Further, the second caulking portion 41 is structured such as to expose the core 5 at a predetermined area from a portion between itself and the first caulking portion 39 corresponding to the periphery of the first caulking portion 39 and between them and the insulator caulking portion 33 in the caulking state of the core 5 at the terminal end of the covered electric wire 9 executed by the core caulking portion 35 and insert the resin within the core 5 at a time of forming the housing 27 mentioned below. In the terminal 25 formed in the manner mentioned above, the housing 27 thereof cover an outer periphery.

The housing 27 is made of a resin having an insulating property, covers an outer periphery between the front end of the contact portion 31 in the terminal 25 and the insulator 7 at the terminal end of the covered electric wire 9, and is inserted in the inner portion from the end portion in another side of the contact portion 31 to the terminal end of the covered electric wire 9. The housing 27 has an insertion opening 51 for inserting an opposing terminal in one side in a longitudinal direction, and communicates an inner portion of the contact portion 31 with an outer side. Further, the housing 27 is structured such that the covered electric wire 9 is drawn to the outer side from another side in the longitudinal direction.

At a time of assembling the connector 23 formed in the manner mentioned above, although an illustration is omitted, the terminal 25 is connected to the terminal end of the covered electric wire 9 so as to form the housing 27 covering the terminal 25 and the outer periphery at the terminal end of the covered electric wire 9. The terminal 25 is connected to the terminal end of the covered electric wire 9 by previously peeling off the insulator 7 at the terminal end of the covered electric wire 9 so as to expose the core 5 and respectively caulking the core caulking portion 35 and the insulator caulking portion 33 of the terminal 25 to the core 5 and the insulator 7.

In a state that the terminal 25 is connected to the terminal end of the covered electric wire 9, the first crimp arm 43 of the first caulking portion 39 and the second crimp arm 47 of the second caulking portion 41 are respectively pressure attached to the core 5, and the terminal 25 is electrically conducted with the covered electric wire 9 by the core caulking portion 35. Further, the terminal 25 is structured such that the supporting arms 37 of the insulator caulking portion 33 are respectively pressure attached to the insulator 7 so as to support the insulator 7, whereby the connecting state to the terminal end of the covered electric wire 9 is kept.

Further, in addition that the core 5 at the terminal end of the covered electric wire 9 protrudes from both sides in the longitudinal direction of the core caulking portion 35 in the same manner as the conventional manner so as to be in an exposing state, the core 5 is in a state exposing at a predetermined area from a portion between the first caulking portion 39 and the second caulking portion 41 and a portion between the second caulking portion 41 and the insulator caulking portion 33.

Further, the core 5 is supported by the second caulking portion 41 at a middle portion between the first caulking portion 39 and the insulator caulking portion 33, an accidental deflection in the middle portion between the first caulking portion 39 and the insulator caulking portion 33 is restricted, and a problem that the core 5 is caught on by the other member at a time of arranging the terminal 25 or the like is prevented.

Further, the housing 27 is formed in the outer periphery of the terminal end of the covered electric wire 9 and the terminal 25. At a time of forming the housing 27, at first, the terminal 25 and the terminal end of the covered electric wire 9 are arranged in an inner portion of a metal mold (not shown), and next a softened resin is charged in the inner portion of the metal mold.

When the softened resin is charged in the inner portion of the metal mold, the resin is charged to the outer peripheral portion of the terminal 25 and the terminal end of the covered electric wire 9, and a portion from another side portion in the longitudinal direction of the contact portion 31 of the terminal 25 to the terminal end of the covered electric wire 9 is in a state of being inserted within the resin. Further, in the terminal end of the covered electric wire 9, the resin is charged within the core 5 from the portion in which the core 5 is in contact with the resin.

At this time, at the terminal end of the covered electric wire 9, the core 5 is in contact with the resin in a softened state from the protruding portions from both sides of the core caulking portion 35, from the portion between the first caulking portion 39 and the second caulking portion 41 and from the portion between second caulking portion 41 and the insulator caulking portion 33, and an efficiency at which the resin is charged within the core 5 is improved. Further, the core 5 at the terminal end of the covered electric wire 9 is in a state that a plurality of conductors 3 are slightly scattered between the first caulking portion 39 and the second caulking portion 41 and between the second caulking portion and the insulator caulking portion 33, and an efficiency at which the resin in the softened state is charged in the inner portion is improved.

As a result, at the terminal end of the covered electric wire 9, the resin in the softened state is securely charged between a plurality of conductors 3 within the core 5 before being cured.

Further, when the resin charged within the metal mold is cured, the housing 27 is formed. In this state, the outer periphery of the terminal end of the covered electric wire 9 and the terminal 25 is covered by the housing 27, and the terminal end of the covered electric wire 9 is inserted in the inner portion of the housing 27. Further, at the terminal end of the covered electric wire 9, since the cured resin is charged between a plurality of conductors 3 within the core 5, it is possible to prevent the water content from invade between the conductors 3.

In the connector 23 according to the present embodiment mentioned above, since the core 5 at the terminal end of the covered electric wire 9 is in the state of protruding from both sides in the longitudinal direction of the core caulking portion 35 in the same manner as the conventional manner and further the core 5 at the terminal end of the covered electric wire 9 is in the state of protruding at the predetermined area from the portion between the first caulking portion 39 and the second caulking portion 41 respectively corresponding to the peripheries of the first and second caulking portions 39 and 41 and the portion between the second caulking portion 41 and the insulator caulking portion 33, an efficiency at which the resin in the softened state is charged between a plurality of conductors 3 within the core 5 at a time of forming the housing 27.

As a result, at a time of forming the housing 27, the resin in the softened state is securely charged between a plurality of conductors 3 within the core 5 so as to be cured, whereby it is possible to securely waterproof between the conductors 3 within the core 5. Accordingly, in the connector 23, it is possible to prevent a plurality of conductors 3 in the core 5 from being oxidized due to the invasion of the water contents into the core 5 of the covered electric wire 9, and it is possible to securely prevent the problems such that the durability of the covered electric wire 9 is reduced, an electric resistance value of the covered electric wire 9 is reduced, or the like.

Further, in the connector 23, in the caulking state of the core 5 at the terminal end of the covered electric wire 9 executed by the core caulking portion 35, a plurality of conductors 3 of the core 5 are in the state of being slightly scattered between the first caulking portion 39 and the second caulking portion 41 and between the second caulking portion and the insulator caulking portion 33. Accordingly, the efficiency at which the resin in the softened state is charged between a plurality of conductors 3 within the core 5 at the terminal end of the covered electric wire 9 at a time of forming the housing 27 is more improved, whereby it is possible to more securely charge the resin in the softened state between a plurality of conductors 3 within the core 5 before being cured.

Further, in the connector 23, since the core 5 is supported by the second caulking portion 41 in the middle portion between the first caulking portion 39 and the insulator caulking portion 33, the accidental deflection in the middle portion between the first caulking portion 39 and the insulator caulking portion 33 is restricted, and it is possible to prevent the problem that the core 5 is caught on the other member at a time of arranging the terminal 25 or the like.

In this case, in the present embodiment mentioned above, the structure is made such as to properly set a length of the core 5 exposed by peeling off the insulator 7 at the terminal end of the covered electric wire 9, and a pitch between the first and second caulking portions 39 and 41 and a pitch between the second caulking portion 41 and the insulator caulking portion 33 in correspondence to a desired time until the resin in the softened state is cured, and expose the core 5 in the caulking state by the core caulking portion 35 at a predetermined area so that the resin can be sufficiently charged within the core 5 at a time of forming the housing 27.

Further, according to the present embodiment, the structure is made such as to expose the core 5 at the predetermined area between the first caulking portion 39 and the second caulking portion 41 and between the second caulking portion 41 and the insulator caulking portion 33, in the state of caulking the core 5 at the terminal end of the covered electric wire 9 by the core caulking portion 35, however, the structure may be made such as to move the second caulking portion 41 close to the insulator caulking portion 33 so as to expose the core 5 at the predetermined area only between the first and second caulking portions 39 and 41.

In this case, by separating the conventional core caulking portion in the longitudinal direction of the terminal so as to be in a state of forming the first caulking portion and the second caulking portion and exposing at the predetermined area between the first caulking portion and the second caulking portion, it is possible to improve a waterproofing performance without increasing the size of the terminal.

Further, in the present embodiment, the core caulking portion 35 is formed by two caulking portions comprising the first caulking portion 39 and the second caulking portion 41, however, it may be constituted by three or more caulking portions. In this case, in a state of caulking the core by the core caulking portion, it is possible to more securely prevent the accidental deflection or the like of the core.

<Second Embodiment>

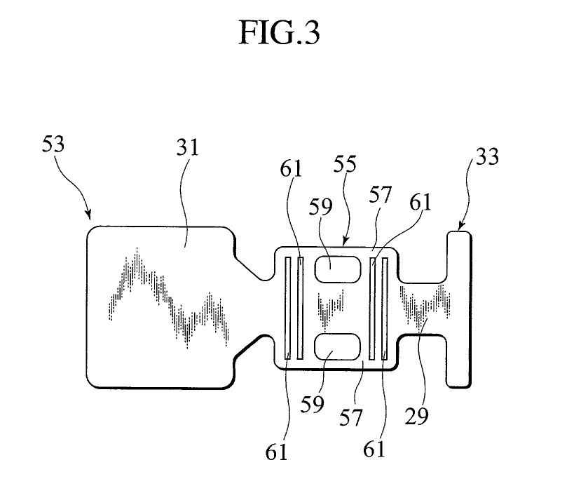

A description will be given below of a second embodiment of the connector according to the present invention with reference to FIG. 3. In this case, the same reference numerals are attached to the same constituting portions as those of the embodiment mentioned above, and a detailed description will be omitted. FIG. 3 is a plan view showing a developing state of a terminal used in the second embodiment of the connector according to the present invention.

The connector according to the present embodiment is structured such that in the connector 23 according to the embodiment mentioned above, a core caulking portion 55 of a terminal 53 is constituted by a pair of pressure attached wall portions 57 and openings 59 are respectively formed in the pressure attached wall portions 57, as shown in FIG. 3.

The terminal 53 is formed in a developed state by punching a metal plate having a conductivity, and is constituted by a rectangular plate-like terminal main body 29, a contact portion 31 provided in one side in a longitudinal direction of the terminal main body 29 and bent in a tubular shape, an insulator caulking portion 33 provided in another side of the terminal main body 29 and caulked to the insulator 7 (not shown) at the terminal end of the covered electric wire 9 (not shown), and a core caulking portion 55 provided between the contact portion of the terminal main body 29 and the insulator caulking portion 33 and caulked to the core 5 (not shown) at the terminal end of the covered electric wire 9.

The core caulking portion 55 core caulking portion 55 is provided with a pair of pressure attached wall portions 57 constituted by a rectangular plate-like body, and the openings 59 respectively provided in the pressure attached wall portions 57. The pressure attached wall portions 57 are extended in a width direction from both sides in the width direction of the terminal main body 29, and are provided along the longitudinal direction of the terminal main body 29. The pressure attached wall portions 57 are formed so as to have a slightly smaller size than the size in the peripheral direction of the outer peripheral surface of the core 5 between front ends. Further, in the pressure attached wall portions 57, a size in a longitudinal direction is set to a size substantially equal to or slightly smaller than the size in the longitudinal direction of the core 5 exposed at the predetermined length by peeling off the insulator 7 at the terminal end of the covered electric wire 9, and the pressure attached wall portions 57 respectively pressure attach the core 5 so as to cover substantially all the area in the caulking state of the core 5 at the terminal end of the covered electric wire 9 executed by the core caulking portion 55. Further, protruding portions 61 respectively engaging the core 5 in both sides in the longitudinal direction are provided between the front ends of the pressure attached wall portions 57, in the caulking state of the core 5 executed by the core caulking portion 55.

The openings 59 provided in the pressure attached wall portions 57 mentioned above are respectively formed in a rectangular shape, and are respectively formed along the longitudinal direction of the pressure attached wall portions 57 between the protruding portions 61 in both sides of the pressure attached wall portions 57. These openings 59 are structured such that the resin is charged within the core 5 at a time of forming the housing 27 (not shown) with exposing the core 5 at the predetermined area, in a state that the core caulking portion 55 is caulked to the core 5 at the terminal end of the covered electric wire 9.

At a time of assembling the connector mentioned above, although an illustration is omitted, the terminal 53 is connected to the terminal end of the covered electric wire 9, and the housing covering the outer periphery of the terminal 53 and the terminal end of the covered electric wire 9 is formed. The terminal 53 is connected to the terminal end of the covered electric wire 9 by previously peeling off the insulator 7 at the terminal end of the covered electric wire 9 so as to expose the core 5 and respectively caulking the core caulking portion 55 and the insulator caulking portion 33 of the terminal 53 to the core 5 and the insulator 7.

In the state that the terminal 53 is connected to the terminal end of the covered electric wire 9, a pair of pressure attached wall portions 57 of the core caulking portion 55 are respectively pressure attached to the core 5 so as to cover substantially all the area of the core 5 by the pressure attached wall portions 57, and the core 5 slightly protrudes from both sides in the longitudinal direction of the pressure attached wall portions 57. Further, the core 5 at the terminal end of the covered electric wire 9 protrudes from both sides in the longitudinal direction of the core caulking portion 55 so as to be exposed, and further protrudes at the predetermined area from the openings 59 of the pressure attached wall portions 57.

Further, the core caulking portion 55 is structured such that the openings 59 eat into the core 5 in a state of being caulked to the core 5, thereby stabilizing mechanical and electrical connections between the core caulking portion 55 and the core 5.

Further, the terminal 53 is structured such that the supporting arms 37 of the insulator caulking portion 33 are respectively pressure attached to the insulator 7 so as to support the insulator 7, whereby a connecting state to the terminal end of the covered electric wire 9 is kept.

Further, the housing 27 is formed in the outer periphery of the terminal end of the covered electric wire 9 and the terminal 53. At a time of forming the housing 27, at first, the terminal 53 and the terminal end of the covered electric wire 9 are arranged in the inner portion of the metal mold (not shown), and next the softened resin is charged in the inner portion of the metal mold.

When the softened resin is charged in the inner portion of the metal mold, the resin is charged to the outer peripheral portion of the terminal 53 and the terminal end of the covered electric wire 9, and a portion from another side portion in the longitudinal direction of the contact portion 31 of the terminal 53 to the terminal end of the covered electric wire 9 is in a state of being inserted within the resin. Further, in the terminal end of the covered electric wire 9, the resin is charged within the core 5 from the portion in which the core 5 is in contact with the resin.

At this time, at the terminal end of the covered electric wire 9, the core 5 is in contact with the resin in the softened state from the protruding portions from both sides of the core caulking portion 55, and the openings 59 of the core caulking portion 55, and the efficiency at which the resin is charged within the core 5 is improved. Accordingly, at the terminal end of the covered electric wire 9, the resin in the softened state is securely charged between a plurality of conductors 3 within the core 5 before being cured.

Further, when the resin charged within the metal mold is cured, the housing 27 is formed. In this state, the outer periphery of the terminal end of the covered electric wire 9 and the terminal 25 is covered by the housing 27, and the terminal end of the covered electric wire 9 is inserted in the inner portion of the housing 27. Further, at the terminal end of the covered electric wire 9, since the cured resin is charged between a plurality of conductors 3 within the core 5, it is possible to prevent the water content from invade between the conductors 3.

In the connector according to the present embodiment mentioned above, since the core 5 at the terminal end of the covered electric wire 9 protrudes from both sides in the longitudinal direction of the core caulking portion 55 and further the core 5 at the terminal end of the covered electric wire 9 protrudes at the predetermined area from the openings 59 of the core caulking portion 55, an efficiency at which the resin in the softened state is charged between a plurality of conductors 3 within the core 5 at a time of forming the housing 27.

As a result, at a time of forming the housing 27, the resin in the softened state is securely charged between a plurality of conductors 3 within the core 5 so as to be cured, whereby it is possible to securely waterproof between the conductors 3 within the core 5. Accordingly, in the connector according to the present embodiment, it is possible to prevent a plurality of conductors 3 in the core 5 from being oxidized due to the invasion of the water contents into the core 5 of the covered electric wire 9, and it is possible to securely prevent the problems such that the durability of the covered electric wire 9 is reduced, an electric resistance value of the covered electric wire 9 is reduced, or the like.

Further, in the connector according to the present embodiment, since the openings 59 eat into the core 5 in the state that the core caulking portion 55 is caulked to the core 5, it is possible to stabilize mechanical and electrical connection between the core caulking portion 55 and the core 5.

Further, in the connector according to the present embodiment, since the openings 59 are only formed in the pressure attached wall portions 57 of the core caulking portion 55, it is possible to easily expose the core 5 at the predetermined area in the state of caulking the core 5 at the terminal end of the covered electric wire 9 by the core caulking portion 55 without increasing the size of the terminal 53.

In this case, in the present embodiment mentioned above, the structure is made such as to properly set a length of the core 5 exposed by peeling off the insulator 7 at the terminal end of the covered electric wire 9, and the size of the openings 59 in correspondence to a desired time until the resin in the softened state is cured, and expose the core 5 in the caulking state by the core caulking portion 55 at a predetermined area so that the resin can be sufficiently charged within the core 5 at a time of forming the housing 27.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A connector comprising:
a covered electric wire with an insulator having an end portion thereof peeled off so that a core is exposed;
a terminal comprising a plurality of pairs of crimp arms rowing in a longitudinal direction thereof and clamping the exposed core and the end of the insulator; and
a housing made of resin having an outer periphery of the terminal and a portion of the insulator molded therein;
wherein the pairs of crimp arms have intervals therebetween and said resin is further impregnated to the core from the intervals.

2. A connector comprising:
a covered electric wire with an insulator having an end portion thereof peeled off so that a core is exposed;
a terminal comprising a caulking portion having one or more pairs of openings and clamping the exposed core and the end of the insulator; and
a housing made of resin having an outer periphery of the terminal and a portion of the insulator molded therein;
wherein the core is partly exposed to said resin from the openings so that said resin is further impregnated therefrom.
